(19) United States
(12) Patent Application Publication
(10) Pub. No.: US 2005/0198168 A1
(43) Pub. Date: Sep. 8, 2005

(54) Messaging protocol discovery

(76) Inventors: Justin Marston, Richmond (GB); Andrew Stuart Hatch, Hurworth-on-Tees (GB)

Correspondence Address: FENWICK & WEST LLP, SILICON VALLEY CENTER, 801 CALIFORNIA STREET, MOUNTAIN VIEW, CA, 94041, US

(21) Appl. No.: 11/004,638

(22) Filed: Dec. 3, 2004

Related U.S. Application Data
(60) Provisional application No. 60/527,214, filed on Dec. 4, 2003.
(60) Provisional application No. 60/570,848, filed on May 12, 2004.
(60) Provisional application No. 60/570,861, filed on May 12, 2004.
(60) Provisional application No. 60/612,436, filed on Sep. 22, 2004.
(60) Provisional application No. 60/612,552, filed on Sep. 22, 2004.

(51) Int. Cl. G06F 15/16

(52) U.S. Cl. 709/206

(57) ABSTRACT

A messaging server (116) supports a relational message transport protocol (RMTP). The RMTP server (116) discovers whether other messaging servers on a network (112) support the RMTP. In pre-discovery, the RMTP server (116) uses (320) simple mail transport protocol (SMTP) command lines to discover whether another messaging server supports RMTP. In post-discovery, the RMTP server (116) encodes the message with data that are recognized by a RMTP server and delivers (324) the data using a conventional protocol such as SMTP. A RMTP server (116) that receives the encoded message initiates (312) a RMTP connection with the sending server. The RMTP server (116) maintains a database of discovered servers (216) and provides a directory interface (218) that other RMTP servers can use to access the database.

### CROSS-REFERENCE TO RELATED APPLICATIONS

This application claims the benefit of U.S. Provisional Application Nos. 60/527,214, filed Dec. 4, 2003, 60/570,848, filed May 12, 2004, 60/570,861, filed May 12, 2004, 60/612,436, filed Sep. 22, 2004, and 60/612,552, filed Sep. 22, 2004, all of which are hereby incorporated by reference herein. This application is related to U.S. patent application Ser. No. 10/789,461, filed Feb. 26, 2004, and Ser. No. 10/977,354, filed Oct. 28, 2004, both of which are hereby incorporated by reference herein.

### BACKGROUND OF THE INVENTION

1. Field of the Invention

This invention pertains in general to electronic messaging and in particular to protocol negotiation among messaging servers.

2. Description of the Related Art

Before the introduction of e-mail, business users relied on two forms of communication—the phone and the business letter. The former was momentary and casual, the latter was retained as a business record and was considered formal. E-mail has blurred those two communication requirements into one tool—people use it both formally and casually, but it is retained for an indefinite time period (typically years) depending on how an enterprise's Information Technology (IT) system has been set up.

Enterprises are now searching for a way to deal with the problem of separating communications that constitute business records from the general ‘chatter’ of e-mail. Such business records must be retained in a manner that reflects the business processes to which the content relates.

A further problem with current e-mail systems is that messages are just simple text strings. When a user writes a message, it is formed into the first e-mail, but may then go on to be included in many other e-mails during its lifetime. This results in many copies of the same, user-authored, message in different, unrelated, mail “snapshots.” Enforcing a retention policy, access rights, security or any other property onto messages thus becomes impossible, as the content cannot be tracked through all of its separate instances in the mail system. This is a very significant problem for companies attempting to achieve regulatory compliance with internal or government-mandated regulations.

Moreover, a typical enterprise, such as a law office, relies on multiple separate software applications to perform its business processes and capture its workflow. For example, the enterprise may use a word processing program to create documents, a document management program to store the documents, a time tracking application to record time for billing purposes, and an accounting program to bill customers. When the members of the enterprise use the applications, the applications typically do an adequate job of fulfilling the business processes and tracking the specific types of workflow to which the applications are directed. For example, a typical document management program usually performs an adequate job of managing documents created by the enterprise. However, members of the enterprise often resist using workflow-capturing applications because of the extra overhead that the applications introduce. As a result, the members might not use the document management program because it requires too much time and/or effort to check documents into, or out of, the system.

Electronic messaging applications are popular business process tools for enterprises because the applications are easy to use and require low overhead. For example, it is usually easier for a person to send a quick email to another person than to draft a memo, store the memo using the document management program, and then print and deliver a copy of the memo. However, electronic messaging applications lack sophisticated workflow-capturing abilities. Consequently, much of an enterprise's workflow remains uncaptured due to people' heavy reliance on electronic messaging. Therefore, the enterprise cannot effectively perform auditing, compliance checking, and other tasks that require sophisticated workflow capture. Accordingly, there is a need in the art for a electronic messaging tool that is easy to use, has low overhead, and provides sophisticated workflow-capturing and auditing abilities.

Furthermore, there is a need for the electronic messaging tool to be interoperable with conventional messaging systems. Users of the messaging tool may need to exchange messages with users of conventional messaging systems. Moreover, the messaging tool may need to communicate over conventional networks and use conventional protocols.

### BRIEF SUMMARY OF THE INVENTION

The above needs are met by a messaging server (116) that supports a relational message transport protocol (RMTP). The RMTP is used to exchange messages in a relational messaging system providing workflow-capturing and auditing capabilities that address the needs described above. The RMTP server (116) also supports conventional messaging protocols such as the simple mail transport protocol (SMTP). The RMTP server (116) can thus be used in heterogeneous network environments (100) where some messaging servers support RMTP while others do not.

The RMTP server (116) discovers whether other messaging servers on the network (112) support the RMTP. In pre-discovery, the RMTP server (116) uses (320) SMTP command lines to discover whether another messaging server supports RMTP. In post-discovery, the RMTP server (116) encodes the message with data that are recognized by a RMTP server and delivers (324) the message using a conventional protocol such as SMTP. A RMTP server (116) that receives the encoded message initiates (312) a RMTP connection with the sending server. The RMTP server (116) maintains a database of discovered servers (216) and provides a directory interface (218) that other RMTP servers can use to access the database.

### BRIEF DESCRIPTION OF THE DRAWINGS

FIG. 1 is a high-level block diagram illustrating one embodiment of an environment including a relational messaging system having servers that are interoperable with conventional messaging servers and protocols.

FIG. 2 is a high-level block diagram illustrating modules within a relational message transport protocol (RMTP) server according to one embodiment.

FIG. 3 is a flow chart illustrating steps performed by a RMTP server when sending a message to another messaging server on the network.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

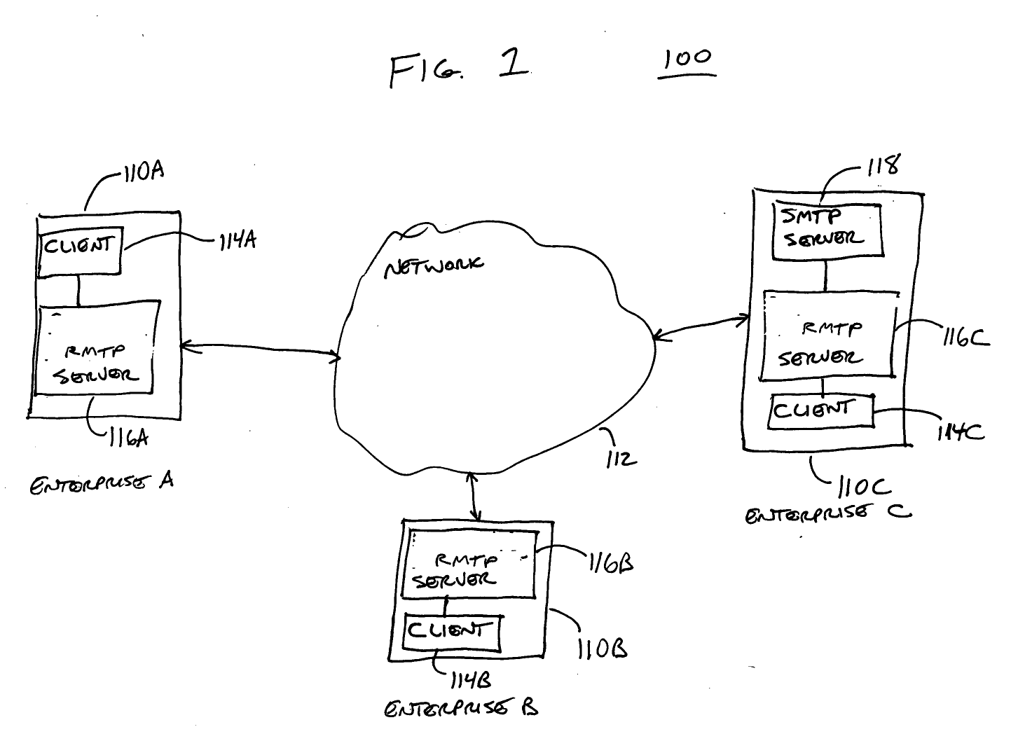

FIG. 1 is a high-level block diagram illustrating one embodiment of an environment 100 including a relational messaging system having servers that are interoperable with conventional messaging servers and protocols. The illustrated embodiment shows three enterprises 110, labeled enterprises “A,” “B,” and “C,” communicating over a network 112. As used herein, an “enterprise” 110 is a business, governmental entity, nonprofit organization, family, or other entity. Only three enterprises 110A, 110B, 110C are shown in FIG. 1 for purposes of clarity. A typical environment 100 can have many enterprises 110 in communication with each other.

FIG. 1 and the other figures use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110A,” “110B,” and “110C” in the figures).

Each enterprise 110 has end-users, such as employees or family members, that send messages to end-users at other enterprises. As used herein, the term “message” refers to a data communication sent by one end-user to one or more other end-users. In one embodiment, at least some of the messages are relational messages as described in U.S. patent application Ser. No. 10/789,461, which is incorporated by reference herein. In this embodiment, a message can be thought of as a container with relational links. The container itself does not contain content, but rather points to submessages and/or attachments in which content resides. When an end-user composes and sends a message, she is actually composing a submessage, and then sending a message containing a reference to the submessage to other end-users. The submessage composed and sent by the end-user is called the “current submessage.” The end-user can also associate one or more attachments with a submessage. In one embodiment, the attachments are relationally linked within a message in the same manner as submessages. Thus, attachments can be treated in the same manner as submessages and descriptions of submessages contained herein are equally applicable to attachments. In some embodiments, the messages are emails, Short Message Service (SMS) messages, Instant Messages (IMs), Multi-Media Messages (MMS) and/or other types of messages. The term “message” can also include media files, such as discrete and/or streaming audio and/or video, still images, etc.

The network 112 enables data communication between the enterprises 110. In one embodiment, the network 112 is the Internet. The network 112 can also utilize dedicated or private communications links that are not necessarily part of the Internet. In one embodiment, the network 112 uses standard communications technologies and/or protocols. Thus, the network 112 can include links using technologies such as Ethernet, 802.1 1, integrated services digital network (ISDN), digital subscriber line (DSL), asynchronous transfer mode (ATM), etc. Similarly, the networking protocols used on the network 112 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), as well as the messaging protocols described below. The data exchanged over the network 112 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the enterprises 110 can use custom and/or dedicated data communications technologies instead of, or in addition to, the ones described above.

For purposes of this description, assume that an end-user within enterprise A 110A composes a message and sends it to end-users in enterprise B 110B and/or enterprise C 110C. The end-user uses a client 114A to compose and send the message. A client is a device utilized by an end-user to compose, send, review, and perform other tasks with the messages. In one embodiment, the client 114A is a computer system executing software modules providing the functionality described herein. In other embodiments, the client is another type of electronic device, such as a personal digital assistant (PDA), cellular telephone with text messaging functionality, portable email device, etc.

The client 114A provides the composed message to a server within enterprise A 110A adapted to operate in the relational messaging system. This server 116A supports a messaging protocol referred to herein as the “Relational Message Transport Protocol” (RMTP) and, therefore, the server is called a “RMTP server.” The RMTP protocol is specially suited for enabling the exchange of relational messages via the network 112.

In one embodiment, the RMTP server 116A is a computer system executing computer program modules for enabling a relational messaging system, as described in U.S. patent application Ser. No. 10/789,461 and the other related applications. For purposes of this description, assume that enterprise B 110B includes a RMTP server 116B and a client 114B. These two entities are functionally identical to their counterparts in enterprise A 110A.

Enterprise C 110C includes a SMTP server 118 in addition to a RMTP server 116C and client 114C. The SMTP server 118B is a conventional email server and may also support additional conventional protocols, such as the Post Office Protocol 3 (POP3). In enterprise C 110C, the SMTP server 118 functions as an email gateway for the enterprise. Thus, a messaging server elsewhere on the network 112, such as the RMTP server 116A in enterprise A 110A that lacks special knowledge about enterprise C 110C will send messages to the SMTP server 118. The SMTP server 118 will store the message and forward it to the RMTP server 116C or other recipient within enterprise C 110C.

As demonstrated by the description of FIG. 1, messaging servers on the network 112 are heterogeneous. Not every messaging server can be expected to support RMTP, and not every messaging server supporting RMTP is necessarily known to the sending server. For these reasons and others, a RMTP server 116 includes functionality allowing it to communicate with non-RMTP enabled messaging servers, such the SMTP server 118 of enterprise C 110C. In addition, a RMTP server 116 includes functionality allowing it to discover and recognize other servers on the network 112 that support RMTP.

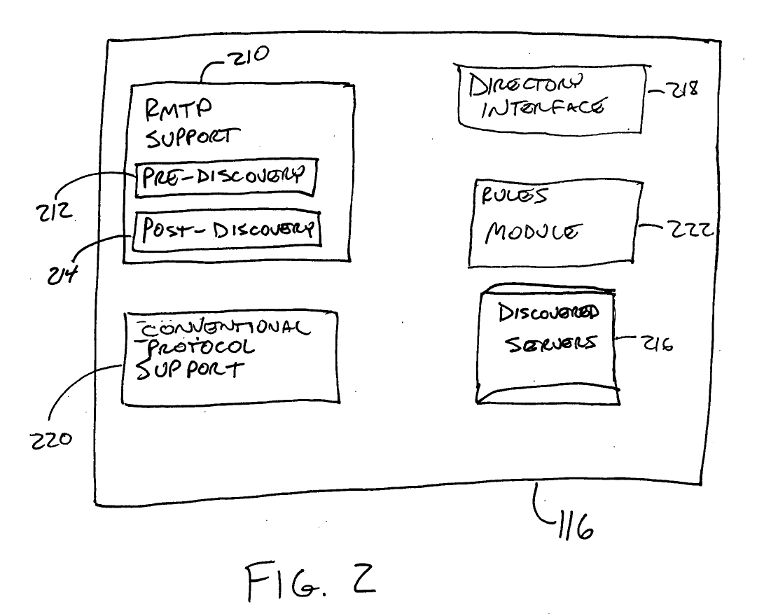

FIG. 2 is a high-level block diagram illustrating modules within a RMTP server 116 according to one embodiment. Those of skill in the art will understand that other embodiments of the RMTP server 116 can have different and/or other modules than the ones described herein. In addition, the functionalities can be distributed among the modules in a manner different than described herein.

The RMTP server 116 includes a RMTP support module 210. This module 210 allows the server 116 to communicate with other RMTP servers using RMTP. RMTP allows native handling of the components of relational messages, including submessages, attachments, and audit data. In addition, RMTP supports other features including data compression, security, auditing, and caching.

In one embodiment, the RMTP support module 210 includes a pre-discovery module 212 that supports early-stage discovery of whether a messaging server supports RMTP. In one embodiment, the pre-discovery module 212 provides functionality to send a set of RMTP server-to-server command lines within an SMTP session established by another RMTP server 116. If the other server supports RMTP, it will respond affirmatively to the command lines. If not, the other server will ignore or not respond appropriately to the command lines. Likewise, the pre-discovery module 212 provides functionality to respond affirmatively to RMTP-specific command lines sent by another server. If the pre-discovery module 212 detects that the other messaging server supports RMTP, it transitions from the initial protocol (such as SMTP) to the RMTP protocol supported by the RMTP support module 210.

For example, in one embodiment the RMTP server 116 assumes that other messaging servers do not support RMTP. When the RMTP server 116 establishes a connection with another messaging server using SMTP, it performs an initial handshaking using the SMTP command lines to determine whether the other server supports RMTP. If the other server does support RMTP, the pre-discovery module 212 transitions from the initial protocol to RMTP.

In one embodiment, the RMTP support module 210 includes a post-discovery module 214 that supports communications with messaging servers that are discovered at a late stage to support RMTP. The post-discovery module 214 provides functionality for encoding a set of RMTP-specific headers into a SMTP message sent by the RMTP server 116. These headers describe a return path, such as an IP address and port number, that a RMTP-enabled server can use to contact the sending RMTP server 116 and initiate a RMTP session. The headers can also include data describing handling instructions for the message. If the sending RMTP server 116 receives a response from a RMTP-enabled server that deciphered the headers of the encoded SMTP message, the post-discovery module 214 causes the RMTP to be used for subsequent message exchanges. Likewise, in one embodiment the post-discovery module 214 includes functionality for interpreting the RMTP-specific headers in a received SMTP message and initiating a RMTP session.

For example, assume a RMTP server 116 is sending a message and pre-discovery fails or does not take place. The RMTP server 116 thus encodes the message with RMTP-specific headers and sends the message via SMTP (or another protocol). If the receiving messaging server is RMTP-enabled, it will analyze the headers and learn that the message was sent by a RMTP server 116. The receiving messaging server contacts the sending RMTP server 116 to inform it that both servers support RMTP. The two servers exchange any subsequent messages and/or audit information via RMTP.

The RMTP support module 210 maintains data describing the RMTP servers it has discovered in a discovered servers database 218. In general, these data describe the addresses of the RMTP servers and the email addresses, domains, or other information that describes for which recipients the RMTP servers are valid. In one embodiment, when the RMTP server 116 receives a message to be delivered, the RMTP support module 210 checks the discovered servers database 216 to determine whether a RMTP server for the recipient is known. If so, the RMTP server 116 sends the message via RMTP. If a RMTP server is not known, the RMTP server 116 attempts to discover a RMTP server for the recipient.

In one embodiment, the data in the database 218 are subject to retention rules. The length of time that data for a given server are maintained in the database 218 is a function of inputs such as the frequency of communication, time since last communication, remaining space for new data, etc. In one embodiment, the discovered servers database 218 include data about the server 116 hosting the database, such as a list of email addresses, domains, etc. served by the server.

In one embodiment, the RMTP server 116 includes a directory interface module 218 that allows the discovered servers database 216 to be queried by other RMTP servers on the network 112. The discovered servers databases 216 within the various RMTP servers 116 on the network 112 thus form a distributed directory of RMTP-enabled servers. In one embodiment, the directory interface 218 allows a request to query whether a particular end-user is supported by a given server 116.

The directory interface module 218 can provide limits on the directory interface to ensure that it cannot be exploited by a malicious actor. For example, the module 218 can limit the number and/or rate of requests that can be performed via the interface in a given time period. Similarly, the directory interface module 218 can disable the interface if a defined number of identity “misses” (i.e., queries answered in the negative) are made within a certain time period.

In one embodiment, the RMTP server 116 includes a conventional protocol support module 220 for supporting messaging using conventional protocols. These protocols can include, for example, SMTP, POP3, the Messaging Application Programming Interface (MAPI), and the Internet Message Access Protocol (IMAP). The server 116 can use the functionality of this module 220 to communicate with non-RMTP servers on the network 112.

In one embodiment, the RMTP server 116 includes a rules module 222 for controlling the operation of the server. The rules module 222 stores one or more sets of rules that describe how the RMTP server 116 should attempt to send messages and/or respond to incoming messages. These rules can be configured by an administrator in order to obtain the desired operation of the RMTP server 116.

For example, in one embodiment the RMTP server 116 acts as the primary messaging server for an enterprise 110. The administrator can create rules that cause the RMTP server 116 to act like a conventional SMTP server when receiving messages from non-RMTP servers on the network 112. Likewise, the administrator can create rules that enable/disable pre- and/or post-discovery, establish default protocols, etc. Further, the administrator can create rules that describe how the RMTP server 116 responds to errors such as a failed RMTP connection and/or invalid data in the discovered servers database 216.

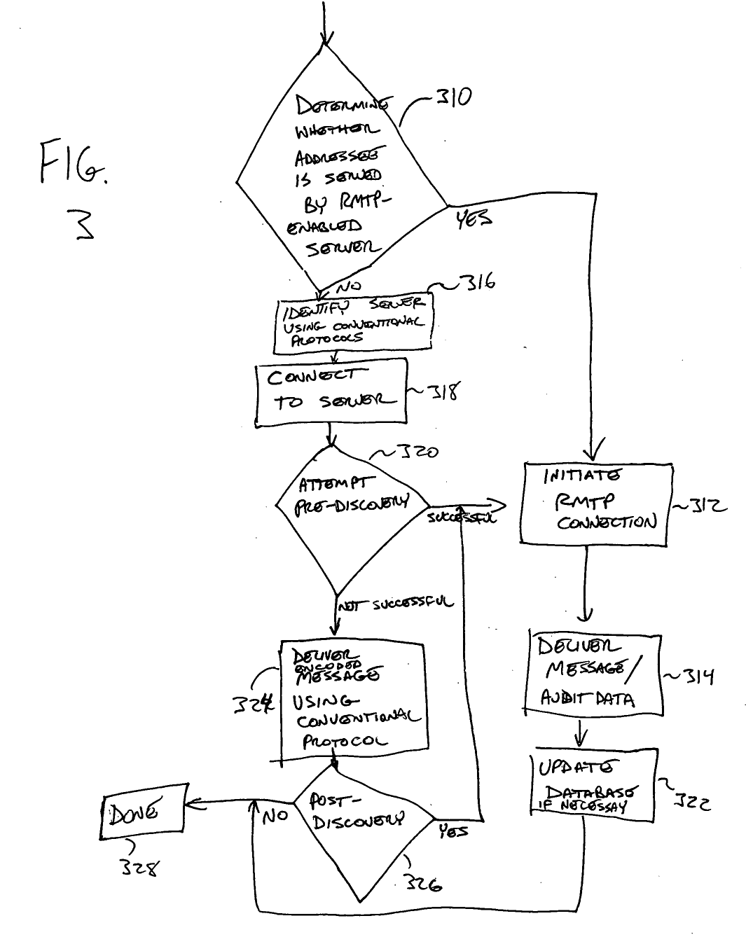

FIG. 3 is a flow chart illustrating steps performed by a RMTP server 116, such as server 116A, when sending a message to another messaging server on the network 112, such as server 116B, server 116C, and/or server 118. A person of skill in the art will recognize that embodiments of the messaging system can perform the illustrated steps in orders different than the one shown in FIG. 3. Moreover, other embodiments can include different steps instead of, or in addition to, the ones described here.

For purposes of this description, assume initially that an end-user using the client 114A at enterprise A 110A composes a message and addresses it to an end-user at enterprise B 110B or enterprise C 110C. The client 114A provides this message to enterprise A's RMTP server 116A. The RMTP server 116A attempts to determine 310 whether the addressee is served by a RMTP server 116. In one embodiment, the RMTP server 116A makes this determination 310 by consulting its discovered servers database 216. The RMTP server 116A can also make this determination 310 by consulting the directory interface 218 of one or more other RMTP servers 116 on the network 112. Thus, if the addressee is located in enterprise B 110B, and enterprise A's RMTP server 116A determines that enterprise B 110B has a RMTP server 116B, enterprise A's RMTP server 116A initiates 312 a RMTP connection with enterprise B's RMTP server 116B and delivers 314 the message.

If enterprise A's RMTP server 116A cannot determine 310 whether the addressee is served by a RMTP server (or the addressee is not served by such a server), then the RMTP server preferably identifies 316 the addressee's messaging server using conventional messaging protocols. In one embodiment, the RMTP server 116A uses or acts as a SMTP Message Transfer Agent (MTA), which is a server that forward messages to their eventual destinations. A MTA uses Domain Name System (DNS) Mail Exchange (MX) records to determine the appropriate messaging server for a given addressee.

Assume that enterprise A's RMTP server 116A identifies enterprise B's RMTP server 116B using MX-records. Enterprise A's RMTP server 116A connects 318 to enterprise B's server 116B using a conventional protocol such as SMTP and engages in 320 pre-discovery to determine whether enterprise B's server supports RMTP. Enterprise A's RMTP server 116A listens for RMTP-specific SMTP command lines from enterprise B's server 116B, and responds affirmatively if it receives the command lines. In one embodiment, the RMTP-specific command lines begin with the code “250”, which distinguishes them from other SMTP lines. If 320 pre-discovery is successful, the servers initiate 312 a RMTP connection and enterprise as server 116A deliver 314 the message and/or audit data using RMTP. The servers 116 also update 322 their respective discovered servers databases 216 to indicate that the other server is RMTP-enabled.

For example, a successful pre-discovery negotiation between the servers 116 of enterprises A 110A and B 110B might occur as follows:

| Party | SMTP line |
|---|---|
| Sender | (opens network connection) |
| Receiver | 220 serverb.com ESMTP Service Ready |
| Sender | EHLO servera.com |
| Receiver | 250-serverb.com |
| Receiver | 250 RMTP; Ports = 7077,35; Version = 1.1 |
| Sender | RMTP recognized - attempting protocol switch |
| Receiver | 250 sender OK |

In this example, enterprise B's server 116B passes the line “250 RMTP; Ports=7077,35; Version=1.1”, indicating that it is a RMTP-enabled server, and that its preferred ports for RMTP connections are 7077 and 35 (in that priority order), and that it is using RMTP version 1.1. Enterprise A's server 116A recognizes the 250 RMTP command, and responds with the line “RMTP recognized—attempting protocol switch.” Enterprise A's server 116A then initiates a RMTP connection to enterprise B's server 116B using one of the preferred ports.

If 320 pre-discovery is not successful, enterprise A's RMTP server 116A encodes the message for post-discovery and delivers 324 the message to the other server. This scenario can occur, for example, if the addressee is located in enterprise C 110C. Enterprise A's RMTP server 116A will connect 318 to enterprise C's SMTP server 118, and pre-discovery will fail because the SMTP server is not RMTP-enabled.

Enterprise A's RMTP server 116A encodes the message by adding SMTP headers similar to the following to the message:
X-RMTP-From: servera.com; 192.168.10.1
X-RMTP-Dir: servera.com; 192.168.10.2
X-RMTP-Data: JFDA29RJALSFAJB90283KSZLSF9210XJFKSLALJZNM283422ZQ
   When enterprise C's SMTP server 118 passes the encoded message to enterprise C's RMTP server 116C, the latter server recognizes that the sending server was RMTP-enabled due to the presence of the “X-RMTP-From” header. Enterprise C's RMTP server 116C will also know that the sending RMTP server has the IP address 192.168.10.1, and that the sending server domain (servera.com) is associated with the indicated directory (X-RMTP-Dir: servera.com; 192.168.10.2). The “X-RMTP-Data” header contains further information on the handling of the message. In one embodiment, enterprise C's RMTP server 116C contacts enterprise A's RMTP server 116C using the address in the header and initiates 312 a RMTP connection. At this point, the servers 116 exchange audit data 314 as may be necessary and update 322 their discovered servers databases 216.

If, for some reason, enterprise A and C's RMTP servers 116A, 116C cannot communicate directly, they can continue to exchange messages using SMTP with the RMTP encoding. Similarly, if the encoded message sent by enterprise A's RMTP server 116A is never received by a RMTP-enabled server, then the RMTP headers will be ignored and post-discovery 326 will never occur. However, the message was delivered successful and thus the delivery process is done 328.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A messaging server adapted for delivering messages on a computer network using a messaging protocol, the server comprising:
a protocol support module adapted to discover other messaging servers on the network that support the messaging protocol; and
a discovered servers database adapted to store data describing the discovered messaging servers on the network that support the messaging protocol.

2. The messaging server of claim 1, wherein the protocol support module comprises:
a pre-discovery module adapted to discover whether a second messaging server supports the messaging protocol before delivery of a message to the second messaging server.

3. The messaging server of claim 2, wherein the pre-discovery module is adapted to engage in communications using simple mail transport protocol (SMTP) command lines to discover whether the second messaging server supports the messaging protocol.

4. The messaging server of claim 1, wherein the protocol support module comprises:
a post-discovery module adapted to discover whether a second messaging server supports the messaging protocol after delivery of a message to the second messaging server.

5. The messaging server of claim 4, wherein the post-discovery module is adapted to encode the message with data recognizable to other messaging servers that support the protocol.

6. The messaging server of claim 1, further comprising:
a directory interface module adapted to provide an interface allowing other messaging servers on the network to access the data stored by the discovered servers database.

7. The messaging server of claim 1, wherein the messaging protocol is a relational messaging protocol.

8. A computer program product having a computer-readable medium having computer program code embodied thereon for delivering messages on a computer network using a messaging protocol, the computer program code comprising:
a protocol support module adapted to discover other messaging servers on the network that support the messaging protocol; and
a discovered servers database adapted to store data describing the discovered messaging servers on the network that support the messaging protocol.

9. The computer program product of claim 8, wherein the protocol support module comprises:
a pre-discovery module adapted to discover whether a second messaging server supports the messaging protocol before delivery of a message to the second messaging server.

10. The computer program product of claim 9, wherein the pre-discovery module is adapted to engage in communications using simple mail transport protocol (SMTP) command lines to discover whether the second messaging server supports the messaging protocol.

11. The computer program product of claim 8, wherein the protocol support module comprises:
a post-discovery module adapted to discover whether a second messaging server supports the messaging protocol after delivery of a message to the second messaging server.

12. The computer program product of claim 11, wherein the post-discovery module is adapted to encode the message with data recognizable to other messaging servers that support the protocol.

13. The computer program product of claim 8, further comprising:
a directory interface module adapted to provide an interface allowing other messaging servers on the network to access the data stored by the discovered servers database.

14. The computer program product of claim 8, wherein the messaging protocol is a relational messaging protocol.

15. A computer-implemented method of delivering a message to an addressee over a computer network, comprising:
identifying a messaging server associated with the addressee of the message;
connecting to the messaging server using a first messaging protocol;
discovering whether the messaging server supports a second messaging protocol; and
if the discovery indicates that the messaging server supports the second messaging protocol, connecting to the messaging server using the second messaging protocol and delivering a message to the messaging server using the second messaging protocol.

16. The method of claim 15, wherein discovering whether the messaging server supports the second messaging protocol comprises:
discovering whether the messaging server supports the second messaging protocol before delivery of a message to the messaging server.

17. The method of claim 16, wherein discovering before delivery of the message comprises:
engaging in communications using simple mail transport protocol (SMTP) command lines to discover whether the messaging server supports the second messaging protocol.

18. The method of claim 15, wherein discovering whether the messaging server supports the second messaging protocol comprises:
discovering whether the messaging server supports the second messaging protocol after delivery of a message to the messaging server using the first messaging protocol.

19. The method of claim 18, wherein discovering after delivery of the message comprises:
encoding the message with data recognizable to other messaging servers that support the second messaging protocol, wherein a messaging server supporting the second messaging protocol that receives the encoded message is adapted to initiate a connection with a messaging server that sent the message using the second messaging protocol.

20. The method of claim 15, further comprising:
storing data describing whether a messaging server supports the second messaging protocol.

21. The method of claim 20, further comprising:
providing an interface wherein messaging servers on the network can access the data describing whether a messaging server supports the second messaging protocol.
